(19) United States
(12) Patent Application Publication
(10) Pub. No.: US 2026/0045967 A1
(43) Pub. Date: Feb. 12, 2026

(54) MITIGATION OF SOUNDING INTERFERENCE IN HIGH FREQUENCY CELLULAR SYSTEMS

(71) Applicant: Rockwell Collins, Inc., Cedar Rapids, IA (US)

(72) Inventors: John V. THOMMANA, Cedar Rapids, IA (US); Joseph SPLEAN, II, Ely, IA (US)

(73) Assignee: Rockwell Collins, Inc., Cedar Rapids, IA (US)

(21) Appl. No.: 18/798,153

(22) Filed: Aug. 8, 2024

(51) Int. Cl. H04B 1/66

(52) U.S. Cl. CPC H04B 1/662

(57) ABSTRACT

A high frequency (HF) cellular system includes base stations and HF terminals that initiate calls in the HF cellular system. The base stations perform sounding operations of transmitting sounding transmissions from the base stations to the HF terminals. A controller within the HF cellular system manages the sounding operations by having the base stations sound at different time intervals at specified frequencies.

### FIELD OF THE INVENTION

The subject matter disclosed herein relates to mitigating sounding interference in high frequency (HF) cellular systems. In particular, the subject matter relates to performing sounding operations within an HF cellular system using base stations and associated methods.

### BACKGROUND OF THE INVENTION

A major source of call blocking in an HF cellular system is related to HF terminal sounding by the user terminals within the system. For a 100-terminal network serviced by 5 base stations, the call blocking probability may vary between 28% and 60% during the course of a day. Sounding interference may account for about 18% of the call blocking failures when the overall call blocking probability was about 28%. Thus, call blocking due to sounding interference is a problem.

It is appreciated that a need exists to prevent or mitigate the interference from terminal sounding operations in an HF cellular system.

### SUMMARY OF THE INVENTION

The present disclosure is directed, in a first aspect, to a method for mitigating sounding interference in a high frequency (HF) cellular system. The method includes transmitting a first sounding transmission from a first base station on a first frequency in a first time interval as specified by a controller communicatively coupled to the first base station. The method also includes transmitting a second sounding transmission from a second base station on a second frequency in the first time interval as specified by the controller communicatively coupled to the second base station.

In some embodiments, the method also includes transmitting a third sounding transmission from the first base station on the second frequency in a second time interval as specified by the controller. The method also includes transmitting a fourth sounding transmission from the second base station on the first frequency in the second time interval as specified by the controller.

In yet another embodiment, the present disclosure is directed to a method for mitigating sounding interference in a high frequency (HF) cellular system. The method includes transmitting a first sounding transmission on a channel from a first base station at a first frequency during a first time interval as instructed by a controller coupled to the first base station. The controller includes a base station table for a plurality of base stations including the first base station and a second base station and a frequency table for a plurality of frequencies including the first frequency and a second frequency. The method also includes transmitting a second sounding transmission on the channel from the second base station at the second frequency during a second time interval as instructed by the controller coupled to the second base station. The method also includes transmitting a third sounding transmission on the channel form the first base station at the second frequency during a third time interval as instructed by the controller. The method also includes transmitting a fourth sounding transmission on the channel from the second base station at the first frequency during a fourth time interval as instructed by the controller.

In yet another embodiment, the present disclosure is directed to a method for mitigating sounding interference in a high frequency (HF) cellular system. The method includes transmitting a first sounding transmission on a channel from a first base station at a first frequency during a first time interval as instructed by a controller coupled to the first base station. The controller includes a base station table for a plurality of base stations including the first base station and a second base station and a frequency table for a plurality of frequencies including the first frequency and a second frequency. The method also includes transmitting a second sounding transmission on the channel from the second base station at the second frequency during a first time interval as instructed by the controller coupled to the second base station. The method also includes transmitting a third sounding transmission on the channel from the first base station at the second frequency during a second time interval as instructed by the controller. The method also includes transmitting a fourth sounding transmission on the channel from the second base station at the first frequency during the second time interval as instructed by the controller.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 illustrates a block diagram of an HF cellular system according to the disclosed embodiments.

FIG. 2 illustrates a schematic diagram of a base station according to the disclosed embodiments.

FIG. 3 illustrates a block diagram of a first base station and a second base station controlled by a controller according to the disclosed embodiments.

FIG. 4 illustrates an example version of a base station table and an example version of a frequency table for use by the controller in sounding operations according to the disclosed embodiments.

FIG. 5 illustrates a chart of an overall call blocking probability comparison between base station sounding and HF terminal sounding according to the disclosed embodiments.

FIG. 6 illustrates a chart of a sounding interference comparison between base station sounding and HF terminal sounding according to the disclosed embodiments.

FIG. 7 illustrates a chart of sounding channels outside a communication channel 702 according to the disclosed embodiments.

FIG. 8 illustrates a flowchart for mitigating sounding interference in the HF cellular system according to the disclosed embodiments.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant disclosed concepts. This is done merely for convenience and to give a general sense of the disclosed concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” “alternative embodiments,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the disclosed concepts disclosed may include one or more of the features expressly described or inherently present herein, or any combination or sub-combination of two or more such features, along with any other features that may not necessarily be expressly described or inherently present in the instant disclosure.

The disclosed embodiments may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

The present disclosure is directed to embodiments to reduce call blocking probability to a manageable level. The disclosed embodiments utilize base station sounding with no HF terminal station sounding to reduce interference. In some instances, interference may be reduced from 18% to less than 1%.

These features are achieved by implementing a controller that ensures that only one base station is sounding at one time. This feature enables the receiver terminals to have a single receiver to receive sounding signals. The base station will sound using an algorithm that permits each receiver to know in advance which frequency on which the base station will be sounding. The controller or the base station may select the sounding frequency in a random order and the terminals do not know on which frequency that base station will sound. Thus, the base station may utilize a wideband auxiliary receiver to receive all propagating signals and the terminals determine the sounding frequency. The controller also may ensure that more than one base station sounds on unique frequencies simultaneously. The terminals also may utilize a wideband auxiliary receiver to receive all sounding frequencies. The base stations may use an auxiliary receiver to receive call requests from multiple terminals simultaneously on multiple frequencies.

In instances where HF terminal station sounding is desired, the disclosed embodiments separate the calling frequencies and the sounding frequencies. When the base stations are sounding, the disclosed embodiments ensure that they are on different frequencies so that the soundings do not interfere with each other. A probability may exist that a terminal is in a call on the frequency on which a frequency is planning to sound. Alternatively, the base station and a terminal select the same time to make a call using the same frequency. This situation may cause occasional interference, which may be mitigated by separating the sounding and calling frequencies. The disclosed embodiments enable adjacent sounding frequencies of +/−100 kHz away that is within a prescribed path loss differential of the communication frequency. This feature allows for sounding in the channels without interfering with the calling and could receive both simultaneously using wideband auxiliary receivers.

Channel sounding may be a holdover from legacy HF communications using automatic link establishment (ALE) for linking. In HF ALE communications, each user terminal periodically sounds on each of the frequencies allocated to the terminal so that other user terminals can determine the best frequencies that propagate from the terminal to each of the user terminals of interest. As a result, the user terminal may select the frequencies with higher call quality above the ones with lower call quality. This operation helped when no operator was present to determine the optimal frequencies to use.

In HF cellular systems, a hub and spoke configuration may be implemented. The communication between two user terminals is performed between a base station and a transportable radio. In addition, the base station includes an overpowered transmitter, transmitting at 1000+ watts equivalent isotropic radiated power (EIRP), as compared to an HF terminal transmitting at 20 watts EIRP. The user terminal sounding does not help the base station because if a call request from the HF terminal can reach the base station, then the 17 dB stronger signal from the base station can definitely reach any peer in the network unless the frequency selected by the base station does not propagate to the peer terminal at that instant.

If all base stations sounded on the same frequency at the same time, then a reasonable probability exists that the different soundings will interfere with each other at the HF terminals to negate the impact of the sounding by base stations. Thus, the disclosed embodiments implement a controller, or control server, that communicates with all the base stations. The controller may initiate the sounding operations from the base stations at different times so that none of the base station soundings overlap.

For five (5) base stations using ten (10) frequencies, this feature results in 50 unique time intervals for sounding. The controller selects that 50 time intervals so that each base station may sound on the channel without interference. This situation is compared to 100 HF terminals sounding randomly on 10 frequencies such that 1000 time intervals were needed on an hourly basis.

The intent of the HF cellular system is to enable fixed site HF stations configured as a network to use the base station with the best connectivity to any of the mobile radio stations to link with that mobile radio station. For example, the base station with the best link to the mobile radio station may respond. At high frequency, this station often is not the nearest station, so there are significant operational benefits to this approach. In some embodiments, each fixed site in an HF cellular system has a single transmitter and a single receiver, operating as a transceiver even when the system uses separate transmit and receive sites.

According to the disclosed embodiments, the system includes a plurality of base stations. Each base station may include a transmitter and two or more receivers. A controller may be communicatively coupled to the base stations in order to control the management of the receivers at the base stations to respond to calls and other signals efficiently and in an optimal manner. The controller may receive information from each base station and evaluate signals received to manage the resources between the base stations.

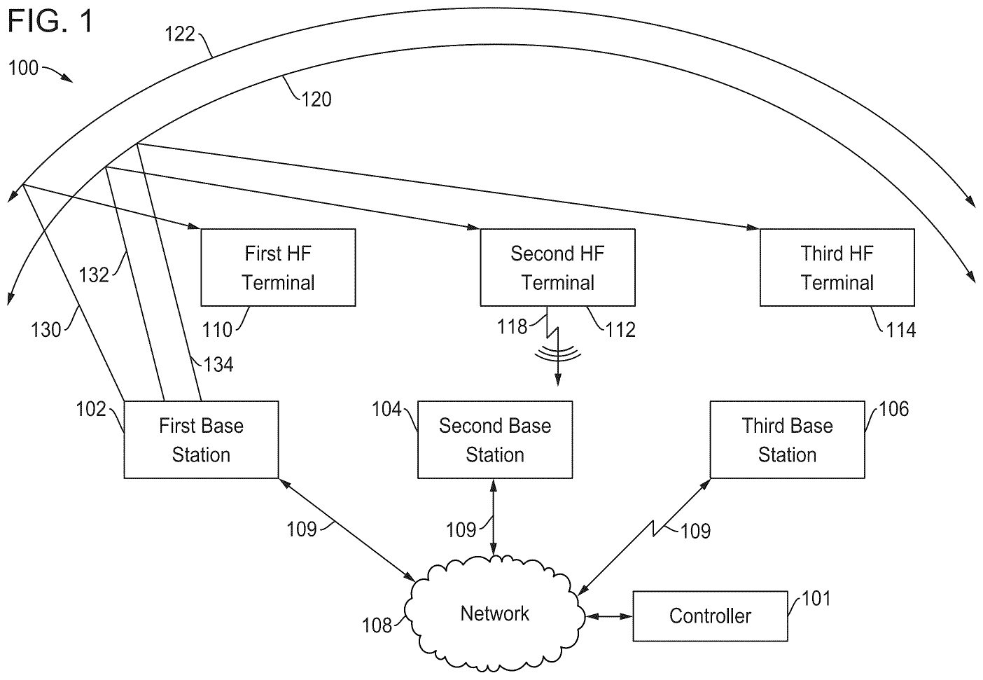

FIG. 1 depicts a block diagram of an HF cellular system 100 according to the disclosed embodiments. HF cellular system 100 may be configured to utilize various layers of the ionosphere to reflect signals and facilitate beyond line of sight reflective communications. For instance, first base station 102 may emit a first signal 130, which may be reflected off a first layer 120 of the ionosphere for delivery to first HF terminal 110. First base station 102 also may emit a second signal 132 that is reflected off a second layer 122 of the ionosphere to second HF terminal 112. First base station 102 also may emit a third signal to be reflected off second layer 122 to third HF terminal 114. It may be appreciated that the base stations and terminals within system 100 are separated by large distances. Further, in alternate embodiments, first base station 102 may send signals 130, 132, and 134 directly to terminals 110, 112, and 114, respectively.

HF cellular system 100 includes first base station 102, as disclosed above. It also includes second base station 104 and third base station 106. System 100 may include additional base stations that are not disclosed here for brevity. System 100 also includes first HF terminal 110, second HF terminal 112, and third HF terminal 114. The HF terminals also may be known as mobile radio stations. Again, additional mobile radio stations may be used within system 100, but not shown here for brevity. Further, although terminals 110-114 are shown “above” base stations 102-106, it may be appreciated that terminals 110-114 are not located at positions above the base stations.

Controller 101 also is included in HF cellular system 100. Controller 101 is coupled to first base station 102, second base station 104, and third base station 106. Controller 101 manages HF cellular operations of the base stations as well as managing calls and operations within the system. Controller 101 may communicate with the base stations through network 108, or, alternatively, it may be connected directly with one or more of the base stations. In some embodiments, controller 101 may be collocated with one of the base stations, such as base station 102. In further embodiments, controller 101 may implement the functions and features of computation component 201, disclosed below.

First base station 102, second base station 104, and third base station 106 may be connected through network 108. In some embodiments, network 108 may include fiber connections 109 between stations 102, 104, and 106 to allow the base stations to exchange information and data. In some embodiments, first base station 102, second base station 104, and third base station 106 may be fixed stations within system 100. Additional base stations, however, may include a mobile base station and connected within network 108 using a combination of fiber or other terrestrial bearer near to the mobile station and a wireless connection from there to the station.

HF terminals 110, 112, and 114 make calls in system 100 using base stations 102, 104, and 106. When an HF terminal calls to an address in system 100, base stations 102, 104, and 106 coordinate with each other to determine which base station takes the call. The base station with the best link to the HF terminal responds. For example, second HF terminal 112 may make call 118. This call goes to each of the three base stations, though not explicitly shown in FIG. 1. The base stations may determine that second base station 104 provides the best performance in taking call 118 so that a link is established with second HF terminal 112.

First base station 102 may initiate sounding transmissions, shown as signals 130, 132, and 134. It may be appreciated that sounding transmissions 130, 132, and 134 normally are not transmitted at the same time. As disclosed above, sounding transmissions allow for evaluating the performance of each channel available for use by the HF terminals within system 100. All HF cellular base stations, such as first base station 102, second base station 104, and third base station 106, have the opportunity to transmit sounding transmissions to first HF terminal 110, second HF terminal 112, and third HF terminal 114 and remain on the channel long enough to evaluate a link between the mobile radio station and the respective base station during the time when each of the sounding transmissions is active.

For example, first base station 102 may transmit sounding transmission 130 to enable all terminals receiving the transmission to evaluate the performance or quality of a potential link with first HF base station 102. It then may transmit sounding transmission 132 to enable all terminals receiving the sounding to evaluate the performance or quality of a potential link with the HF base station 102. It then may emit sounding transmission 134 to enable all terminals receiving the sounding to perform the evaluation for a potential link to HF base station 102. The HF terminals look for the sounding transmissions in order to determine the best frequencies to select to initiate a call within system 100.

The terminal evaluation may measure the signal strengths of sounding transmissions 130, 132, and 134. Each channel at a base station may be evaluated. For example, first base station 102 may define a table or sounding transmission list that includes all the channel numbers associated with the frequencies to be measured. First base station 102 may have a sounding order, such as from lowest channel number to highest channel number. This process may be synchronous or asynchronous. For a synchronous operation, the time at which transmissions occur on specific channels may be known a priori. This feature allows receivers to look at the channel at the correct time to receive a signal. For asynchronous operation, any channel may be accessed at any time. When base stations are sounding, the transmission should be long enough for the terminals to cycle through all frequencies to determine the sounding frequency if the terminal has a single receiver. If the terminal includes a wideband auxiliary receiver then the sounding need not be as long because the terminals may receive all propagating frequencies and determine the sounding frequency in a much shorter time.

When an HF terminal makes a call into HF cellular system 100, stations that are not linked have the opportunity to hear the call and may be chosen to respond accordingly based on reception quality. For example, second HF terminal 112 may initiate call 118. Call 118 is treated as an incoming call by first base station 102, second base station 104, and third base station 106. The quality of the received call at each base station is determined to decide which base station will respond. In this instance, second base station 104 may have the best reception quality for establishing a link to second HF terminal 112 to accept call 118.

Controller 101 may determine which base station will respond based on the received quality of the call at each base station. The preamble in the call request for call 118 may be used by all base stations hearing the call request to determine the link quality and report it to controller 101.

Call blocking may occur when all base stations are busy with links or received calls from the HF terminals. For example, call 118 may be blocked if first base station 102, second base station 104, and third base station 106 are busy with transmitting/receiving sounding transmissions, other calls or in links. Further, if the base stations are configured to receive sounding transmissions from HF terminals, then these operations could block call 118. The disclosed embodiments, however, have the base stations send the sounding transmissions so that such call blocking should not occur based on sounding transmissions from HF terminals.

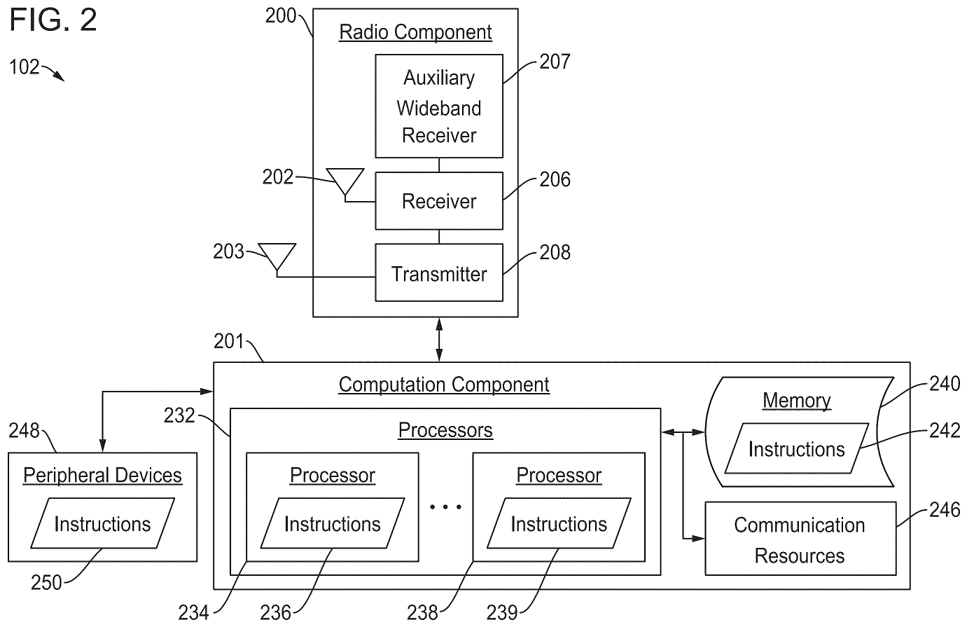

FIG. 2 depicts a schematic diagram of a base station according to the disclosed embodiments. FIG. 2 also may depict a schematic diagram of HF terminals 110, 112, and 114. A potential difference between the base stations and the mobile radio stations of the disclosed embodiments is that the base stations are communicatively coupled through infrastructure, such as network 108, while HF terminals rely on HF links to reach into the network. FIG. 2 refers to first base station 102 but the disclosure also may pertain to second base station 104 or third base station 106. Each station may include at least one radio component 200 having the features disclosed below. First base station 102 also may include computation component 201, which also acts as part of the network infrastructure for HF cellular system 100. Stations 104, 106 and HF terminals 110, 112, and 114 also may include one or more features of computation component 201.

It may be appreciated that first base station 102, along with base stations 104 and 106, are communicatively coupled to controller 101, which may perform the function of evaluating signal quality of receptions and determines which base station will respond to calls. Controller 101 also may be used to embody other features of the disclosed embodiments, such as coordinating hand-offs or controlling receive scan timings at individual receivers. First base station 102 also may be operated in a split site mode that have connectivity between a transmitter, a receiver, or a wideband auxiliary receiver.

Radio component 200 may send and receive high frequency (HF) signals within HF cellular system 100. An HF signal refers to a wireless electromagnetic signal used as a form of communication or to transmit data. The HF signal may be a form of electromagnetic radiation with identified radio frequencies with different bands. Frequency refers to the rate of oscillation of the radio waves of the HF signals. Each band has different capabilities. For example, the frequency range of the HF signals may be from 2 to 30 MHz, but may also include frequencies as low as 1.5 MHz or as high as 60 MHz. It may be appreciated that the disclosed embodiments are not limited to these frequency ranges.

Radio component 200 includes antenna 202, receiver 206, and transmitter 208. Antenna 202 may transmit and receive HF signals within HF cellular system 100. Antenna 202 converts electrical signals into electromagnetic waves. Antenna 202 may be one of a variety of types of antennas, such as whip, dipole, monopole, and Yagi-Uda antennas. Antenna 202 may radiate or receive the electrical signals over a certain range of frequencies.

One or more receivers may be coupled to antenna 202. Transmitter 208 may be coupled to a separate antenna 203, which is similar in function and design to antenna 202. In some embodiments, receiver 206 and transmitter 208 may be embodied in a transceiver for radio component 200 such that these components are connected to a single antenna for transmit and receive.

Referring to receiver 206, this part of radio component 200 manages the reception of HF signals within system 100 according to a communication protocol. First base station 102 may include more than one receiver 206 such that different signals may be detected and received at radio component 200. Receiver 206 also may convert the received signals into data to be provided to computation component 201.

Transmitter 208 also is part of radio component 200. Transmitter 208 may receive an input signal. The input signal may be a voltage input to control the amplitude and/or phase of the frequency of transmitter 208. The generated HF signal transmits from radio component 200 using antenna 203.

These features of radio component 200 may differ depending on the application of first base station 102. Further, they may differ for implementation within stations 104, 106 and HF terminals 110, 112, and 114. Depending on the functionality desired by first base station 102 and HF cellular system 100, radio component 200 may operate differently than disclosed above. For example, additional filters or amplifiers may be included within receiver 206 or transmitter 208. Further, additional receive channels may be defined such that different receivers 206 may be implemented.

First base station 102 also may include computation component 201. Second base station 104 and third base station 106 also may include a computation component 201. Controller 101 also may include a computation component 201. Computation component 201 may be part of the network infrastructure that manages the access of nodes within HF cellular system 100. Computation component 201 may receive processed signals from one or more receivers 206 or to transmit signals through one or more transmitters 208. Further, computation component 201 may include applications that use signals to derive information within HF cellular system 100.

Computational component 201 may be able to read instructions for a machine-readable or computer-readable medium and perform one or more of the functions disclosed herein. Computational component 201 includes one or more processors 232, one or more memory, or storage, devices 240, and one or more communication resources 246. These features may be communicatively coupled to each other.

Processors 232 may include a processor 234 and a processor 238. The term processor also may refer to a processor core within computational component 201. Processors 232 and 238 may be a central processing unit (CPU), a reduced instruction set computing (RISC) processor, a complex instruction set computing (CISC) processor, a graphics processing unit (GPU), a digital signal processor (DSP) such as a baseband processor, an application-specific integrated circuit (ASIC), a field-programmable gate array (FPGA), a radio-frequency integrated circuit (RFIC), and the like.

Memory devices 240 may include a main memory, disk storage, or any combination thereof. Memory devices 240 may include but are not limited to, any type of volatile, non-volatile, or semi-volatile memory such as dynamic random access memory (DRAM), static random access memory (SRAM), erasable programmable read-only memory (EPROM), electrically erasable programmable read-only memory (EE-PROM), flash memory, solid-state storage, and the like. Peripheral devices 248 also may be memory devices having similar features.

Communication resources 246 may include interconnection or network interface controllers, components, or other suitable devices to communicate with one or more peripheral devices 248. First base station 102 may use radio component 200 for communicating over HF cellular system 100 but communication resources 246 also may be used to interface with components within network 108.

Instructions 236, 239, 242, and 250 may include software, a program, an application, an applet, an app, or other executable code for causing the respective processors to perform the functionality and operations disclosed herein. Instructions 236 may configure processor 234 to execute operations. Instructions 239 may configure processor 238 to execute operations in addition to the operations executed by processor 234. Instructions 236 and 239 may reside, completely or partially, within processors 234 and 238, respectively. These instructions also may reside in memory devices 240 as instructions 242 or in peripheral devices 248 as instructions 250. Instructions 242 and 250 may be transferred to processors 232.

In some embodiments, radio component 200 may include an auxiliary wideband receiver 207 for use by a base station or an HF terminal in addition to receiver 206. Auxiliary wideband receiver 207 may be a secondary receiver configured to capture signals across a wide frequency spectrum. Auxiliary wideband receiver 207 complements receiver 206, which is the primary receiver, by providing additional capabilities or extended functionality. The operations associated with auxiliary wideband receiver 207 are disclosed in greater detail below.

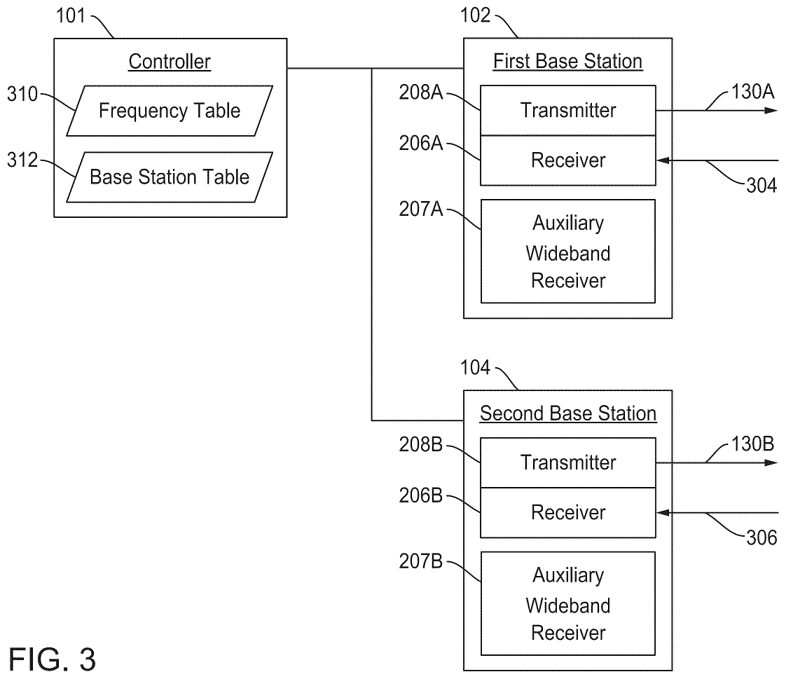

FIG. 3 depicts a block diagram of first base station 102 and second base station 104 controlled by controller 101 according to the disclosed embodiments. Controller 101 is connected to first base station 102 and second base station 104. Controller 101 may select frequencies and time intervals for the base stations to send sounding transmissions into HF cellular system 100. Controller 101 may select the frequencies and time intervals using a variety of processes.

As shown in FIG. 3, first base station 102 and second base station 104 are shown in greater detail than FIG. 1. First base station 102 include transmitter 208A and receiver 206A as well as auxiliary wideband receiver 207A. Second base station 104 includes transmitter 208B and receiver 206B as well as auxiliary wideband receiver 207B. Transmitter 208A and receiver 206A of first base station 102 may form a frequency channel that uses a pair of frequencies for the transmission and reception of signals. Transmitter 208B and receiver 206B of second base station 104 also may form a frequency channel that uses a pair of frequencies for the transmission and reception of signals. The frequency channel may be a specific portion of the radio frequency spectrum allocated for communication within HF cellular system 100. The frequency channel may be defined by a specific bandwidth and a central frequency.

First base station 102 and second base station 104 may transmit in different frequency channels or the same frequency channel based on the frequencies used for transmission and reception. A frequency channel may use a frequency for transmission from transmitter 208A, referred to as the downlink channel. The frequency channel also may use a frequency for reception of a signal at receiver 206A, referred to as the uplink channel. Second base station 104 may use these frequencies or other frequencies in establishing its own frequency channel.

The base stations may transmit sounding transmissions in the frequency channels configured therein. For example, first base station 102 may transmit sounding transmission 130A within the frequency channel using transmitter 208A. Sounding transmission 130A may be transmitted at a specified frequency during a specified time interval. Similarly, second base station 104 may transmit sounding transmission 130B within the frequency channel using transmitter 208B. Sounding transmission 130B may be transmitted a specified frequency during a specified time interval. The specified frequencies for the different sounding transmissions may differ or may be the same. The specified time intervals also may differ or may be the same.

For example, controller 101 may include base station table 310 and frequency table 312 to select which base station, frequency, and time interval to sound. The sounding operations may occur in a channel at the selected base station. For example, controller 101 may instruct first base station 102 to transmit, or sound, sounding transmission 130A at a frequency within a frequency channel at a specified time interval. It also may instruct second base station 104 to transmit, or sound, sounding transmission 130B at the same frequency in a different time interval as sounding transmission 130A, or at a different frequency in the same time interval.

The frequencies and time intervals used to send sounding transmissions are selected by controller 101. Controller 101 may do so randomly so that a random base station is picked to send the sounding transmission. It also may do so using a specified order, such as using entries in base station table 310 and frequency table 312.

First base station 102 also may receive a signal 304 from an HF terminal within HF cellular system 100. Second base station 104 may receive a signal 306 from an HF terminal within system 100. Signal 304 and signal 306 may be calls from terminals using the frequency channel. Alternatively, signals 304 and 306 may be sounding transmissions from the terminals. If a transmitter for the channel is transmitting, then a call may be blocked coming into the base station. For example, if transmitter 208A is sending sounding transmission 130A, then signal 304 may be blocked, thereby causing interference within system 100. The disclosed embodiments mitigate interference caused by sounding operations.

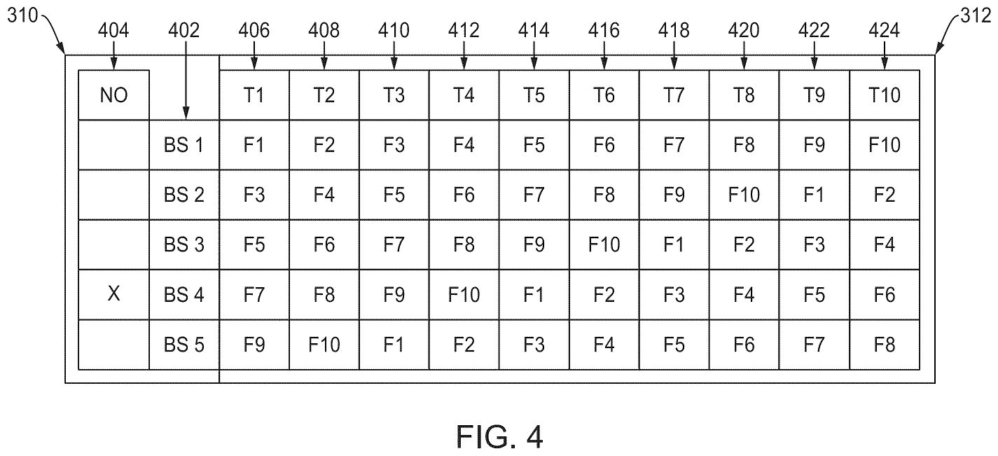

In managing sounding operations, controller 101 may use one or more tables to select which base station will sound at a selected frequency during a selected time interval. As shown in FIG. 3, controller 101 may use base station table 310 and frequency table 312. FIG. 4 depicts an example version base station table 310 and an example version of frequency table 312 for use by controller 101 in sounding operations according to the disclosed embodiments. Tables 310 and 312 are shown together to better illustrate the relationships between the base stations and frequencies.

Tables 310 and 312 may include fields, shown by rows and columns, that include data for use by controller 101 in assigning a base station to a frequency during a time interval. As disclosed below, columns will be used in reference to the fields of data in the table. For example, base station table 310 includes columns 402 and 404. Column 402 relates the base stations connected to controller 101 and used for sounding operations. Column 402 includes five base stations, but may include 10 base stations or any number. Base station 1 may refer to first base station 102 disclosed above along with base station 2 referring to second base station 104 and base station 3 referring to third base station 106. Base station 4 and base station 5 in column 402 are not shown in FIG. 1 but are a part of HF cellular system 100.

Column 404 may include fields to designate that the corresponding base station is to not be used in sounding operations. For example, for base station 4, a field may be marked so that base station 4 is not used in sounding operations by controller 101. Base station 1, base station 2, base station 3, and base station 5 still are used in sounding operations. In some instances, all base stations may be silenced so that no sounding occurs and the reception of calls from HF terminals is emphasized in HF cellular system 100.

When controller 101 wishes to enable sounding operations, it may select a base station from base station table 310. This process may be random in that controller 101 selects a base station when a sounding operation needs to be performed. Controller 101 also may randomly select a frequency from frequency table 312 to be used for sounding. Alternatively, controller 101 may select the appropriate base station and frequency based on an ordered combination within frequency table 312 and base station table 310.

For example, controller 101 may pick 50 unique time intervals for five base stations and ten frequencies to sound a channel. Referring to FIG. 4, column 406 corresponds to time interval T1, column 408 corresponds to time interval T2, column 410 corresponds to time interval T3, column 412 corresponds to time interval T4, column 414 corresponds to time interval T5, column 416 corresponds to time interval T6, column 418 corresponds to time interval T7, column 420 corresponds to time interval T8, column 422 corresponds to time interval T9, and column 424 corresponds to time interval T10.

Each base station sounds the frequency channel formed by its transmitter at ten different frequencies during these time intervals. Controller 101 makes sure that for a given time interval, no base station is sounding on the same frequency as another base station. Thus, for time interval T1, base station 1 sounds on frequency 1, base station 2 sounds on frequency 3, base station 3 sounds on frequency 5, base station 4 sounds on frequency 7, and base station 5 sounds on frequency 9. For time interval T2, base stations 1, 2, 3, 4, and 5 sound on the “even” numbered frequencies of frequency 2, frequency 4, frequency 6, frequency 8, and frequency 10, respectively.

As may be shown, base station 1 sounds on a different frequency 1-10 for each time interval T1-T10. Base station 1 does not sound the same frequency twice during the time intervals. Base station 2 also sounds on a different frequency for its time intervals T1-T10 but starts with frequency 3 in time interval T1, then increases the frequency number until time interval T9, when it sounds frequency 1, and time interval T10, when it sounds frequency 2. Base station 3 also sounds on a different frequency for its time intervals T1-T10 but starts with frequency 5 in time interval T1, then increases the frequency number until time interval T7, when it sounds frequency T1. Base station 4 also sounds on a different frequency for its time intervals T1-T10 but starts with frequency 7 in time interval T1, then increases the frequency number until time interval T5, when it sounds frequency T1. Base station 5 also sounds on a different frequency for its time intervals T1-T10 but starts with frequency 9 in time interval T1, then increases the frequency number until time interval T3, when it sounds frequency T1.

Many such combinations may be created where multiple base stations sound the channel at the same time. Because the disclosed embodiments are sounding from all base stations simultaneously, they cannot handle calls during the sounding period. Yet, using the scheme disclosed above, the number of time intervals may be reduced to 10 as opposed to 50 or more time intervals needed for sounding from HF terminals.

One issue may be if the HF terminals cannot handle reception of multiple frequencies simultaneously. In some embodiments, the HF terminals may include a wideband receive only receiver that can receive multiple channels simultaneously. For example, the receiver may be a wideband auxiliary receiver operating at 2 to 30 MHz and digitizes the entire frequency band to receive multiple channels.

In some embodiments, controller 101 can allocate 10 sounding intervals at the start of every hour for all HF terminals receiving sounding from multiple base stations simultaneously. There may be 360 10 second intervals in one hour. The allocation of ten 10 second intervals leaves 345 time intervals for call requests with the last 5 time interval slots being reserved for successful call requests in the 345^{th} slot to continue successfully. In alternative embodiments, controller 101 can allocate a second sounding session in the middle of the one hour periods. The disclosed embodiments have the option of sounding on all frequencies twice or sounding on half of the frequencies in each sounding session.

During the sounding operations, all HF terminals may hear the sounding transmissions from the base stations in base station table 310 if the frequencies in use propagate to the HF terminals. In some operations, this may be a one-way exchange.

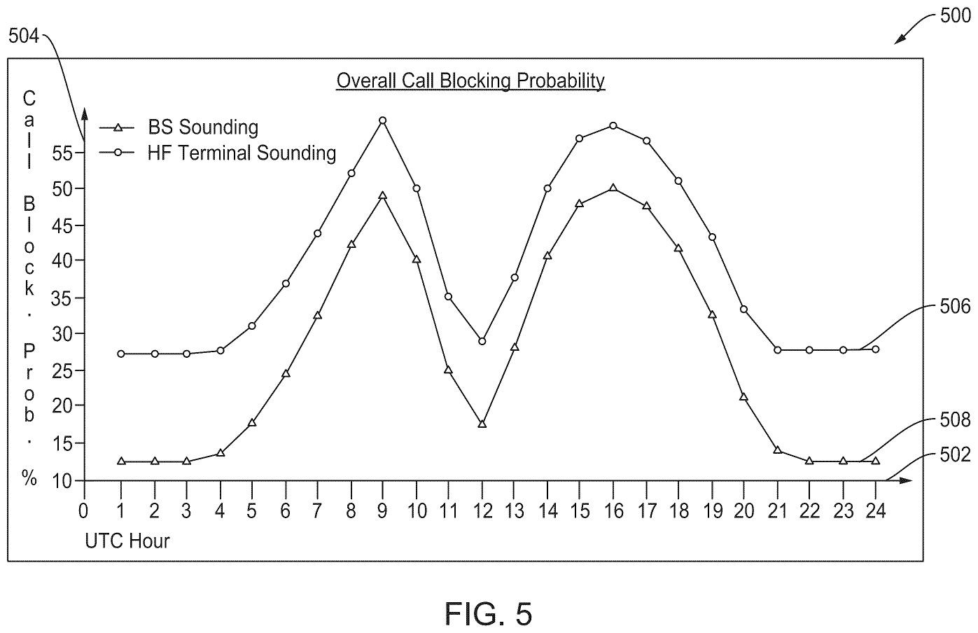

FIG. 5 depicts a chart 500 of an overall call blocking probability comparison between base station sounding and HF terminal sounding according to the disclosed embodiments. Chart 500 includes axis 502 of the coordinated universal time (UTC) for the period of calls, such as one day shown by hours 1 through 24. Axis 504 shows the call blocking probability percentage of calls blocked during the times shown in chart 500.

Line 506 shows the call blocking probability of calls during the UTC hours when system 100 uses HF terminal sounding where the HF terminals send sounding transmissions to the base stations. For example, HF terminals 110, 112, and 114 sound in system 100 to base stations 102, 104, and 106. The call blocking probability changes during a day from a low of about 27% to a high over 55%, depending on the time of day.

In contrast, base station sounding results in a 10-15% reduction in the overall call blocking probability when the base stations sound randomly without interference. Line 508 shows this call blocking probability during the UTC hours when base station sounding is managed by controller 101. The call blocking probability changes during a UTC day from a low of about 12% to a high of about less than 50%. Thus, the implementation of base station sounding operations according to the disclosed embodiments result in reduced call blocking probabilities throughout the day.

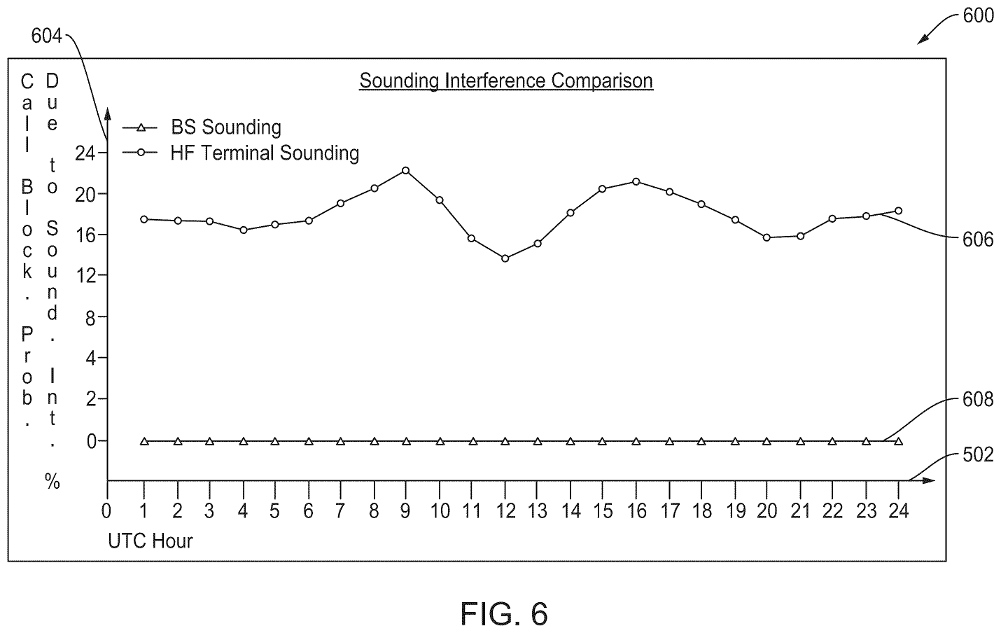

FIG. 6 depicts a chart 600 of a sounding interference comparison between base station sounding and HF terminal sounding according to the disclosed embodiments. Chart 600 includes axis 502 and axis 604. Axis 502 shows the UTC hour, as disclosed above. Axis 604 relates to the call blocking probability due to sounding interference. This type of call blocking is due to sounding transmissions being transmitted from the base station or received at the base station for the channel being sounded.

Line 606 shows the probability of calls being blocked due to sounding performed by HF terminals. As can be seen, these probabilities vary during the course of the day between about 14% and about 22%. In contrast, line 608 shows that the probability of call blocking due to base station sounding is about 0%. In some embodiments, if an HF terminal sends a call request on a specific frequency when one of the base stations is sounding on the same frequency at the same time interval, then the call does not always get blocked. The base station sending the sounding transmission cannot process the call but if there is even one base station that is free then the call blocking become statistical in that the call gets blocked only if the sounding transmission overpowers the call request at the other base stations. Further, there are conditions when the sounding frequency of one base station does not propagate to the other base stations.

In some embodiments, HF terminal sounding may be desired. This process may occur where terminals can call terminals directly if needed without having to go through the base station. The HF terminals can hear sounding signals from other user terminals on all propagating frequencies without interfering with the calls. The base stations also can hear the sounding transmissions from all HF terminals without interfering with the frequencies used for calling. This feature also helps in the case of base station sounding as the terminals can process calls and soundings simultaneously.

Sounding and calling frequencies may be separated to prevent sounding frequencies from interfering with the calling frequencies. For each traffic frequency allocate a sounding frequency that is within +/−100 kHz from the calling frequency. The sounding frequency link quality measurement can be used to determine the link quality of the calling frequency.

Referring to first base station 102, the high EIRP forces the deployment in a split-site configuration. At the terminals, such as first HF terminal 110, because the transmission EIRP is low, such as +43 dBm, and the terminal communicates via a narrowband (3 kHz) or wideband (48 kHz) channel, the disclosed embodiments may be able to receive sounding transmissions at +/−100 kHz away using the auxiliary receiver. Even if the transmission using transmitter 208A at first base station 102 is occurring, it will be able to receive sounding transmissions on frequencies a MHz away.

The disclosed embodiments may use antenna 203 for the main channel of transmitter 208 and receiver 206 and auxiliary wideband receiver 207 if radio component 200 is willing to not hear while the terminal is transmitting. This feature allows for multiple user to sound at the same time as they could each be assigned different slots within the band. The disclosed embodiments may support instantaneous bandwidths of up to 48 kHz, but higher instantaneous bandwidths may be supported in future. Allocations could be made to cut out part of the band to allow for sounding separation form communication. Alternatively, sounding operations may be just outside the communication band to prevent potential interference with communications.

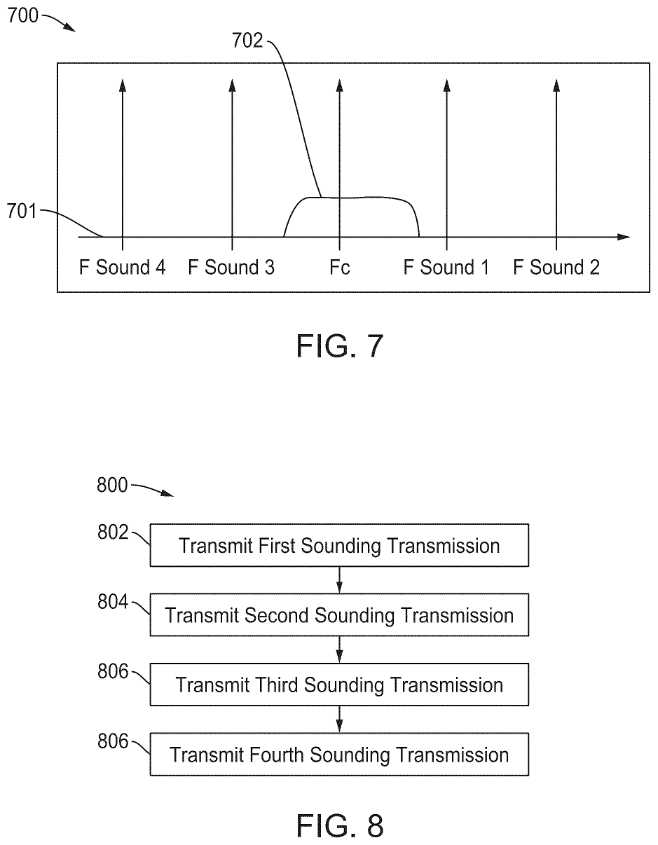

FIG. 7 depicts a chart 700 of sounding channels outside a communication channel 702 according to the disclosed embodiments. Communication channel 702 has a communication bandwidth with the RF spectrum of axis 701. Call frequency Fc is within communication channel 702. A call, such as call 118, may be received or placed on call frequency Fc. Further, multiple sounding frequencies also may be assigned either above or below communication channel 702. Even if communication is happening on a channel, other radios would be able to sound within interference to communications.

Sounding frequency 1 and sounding frequency 2 are assigned offsets above communication channel 702 along axis 701 for the RF spectrum for HF cellular system 100. Sounding frequency 3 and sounding frequency 4 are assigned offsets below communication channel 702. This feature allows multiple users to sound at the same time. Controller 101 may instruct base stations or HF terminals to sound as desired without interference to other radios. This feature also allows for many devices to provide good sounding data and not worry about timing and overlap blocking the signals or calls within HF cellular system 100.

FIG. 8 depicts a flowchart 800 for mitigating sounding interference in HF cellular system 100 according to the disclosed embodiments. Flowchart 800 may refer to FIGS. 1-7 for illustrative purposes. Flowchart 800, however, is not limited to the embodiments disclosed by FIGS. 1-7.

Step 802 executes by transmitting a first sounding transmission from first base station 102. In some embodiments, the first sounding transmission relates to sounding transmission 130A from transmitter 208A of first base station 102. The first sounding transmission is transmitted on a channel at first frequency, such as frequency 1, during a time interval, such as time interval T1 from first base station 102. Controller 101 instructs first base station 102 to transmit the first sounding transmission. In some embodiments, controller 101 selects first base station 102 and selected frequency using base station table 310 and frequency table 312.

Step 804 executes by transmitting a second sounding transmission from second base station 104. In some embodiments, the second sounding transmission relates to sounding transmission 130B from transmitter 208B of second base station 104. The second sounding transmission also is transmitted on the channel at a second frequency, such as frequency 4, during a second time interval, such as time interval T2 from second base station 104. Alternatively, step 804 may execute by transmitting the second sounding transmission on the channel at a second frequency, such as frequency 3, during the first time interval, or time interval T1. Controller 101 instructs second base station 104 to transmit the second sounding transmission. In some embodiments, controller 101 selects second base station 104 and selected frequency using base station table 310 and frequency table 312.

Step 806 executes by transmitting a third sounding transmission from first base station 102. In some embodiments, the third sounding transmission relates to sounding transmission 130A from transmitter 208A of first base station 102. The third sounding transmission may be transmitted on the channel at the second frequency, such as frequency 4, during a third time interval, such time interval T4 from first base station 102. Alternatively, step 806 may execute by transmitting the third sounding transmission on the channel at the second frequency, such as frequency 2, during a second time interval, such as time interval T2. Controller 101 instructs first base station 102 to transmit the third sounding transmission. In some embodiments, controller 101 selects first base station 102 and selected frequency using base station table 310 and frequency table 312.

Step 808 executes by transmitting a fourth sounding transmission from second base station 104. In some embodiments, the fourth sounding transmission relates to sounding transmission 130B from transmitter 208B of second base station 104. The fourth sounding transmission may be transmitted on the channel at the first frequency, such as frequency 1, during a fourth time interval, such time interval T7 from second base station 104. Alternatively, step 808 may execute by transmitting the fourth sounding transmission on the channel at the second frequency, such as frequency 3, during the second time interval, such as time interval T2. Controller 101 instructs second base station 104 to transmit the fourth sounding transmission. In some embodiments, controller 101 selects second base station 104 and the selected frequency using base station table 310 and frequency table 312.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A method for mitigating sounding interference in a high frequency (HF) cellular system, the method comprising:
transmitting a first sounding transmission from a first base station on a first frequency in a first time interval as specified by a controller communicatively coupled to the first base station; and
transmitting a second sounding transmission from a second base station on a second frequency in the first time interval as specified by the controller communicatively coupled to the second base station.

2. The method of claim 1, further comprising:
transmitting a third sounding transmission from the first base station on the second frequency in a second time interval as specified by the controller; and
transmitting a fourth sounding transmission from the second base station on the first frequency in the second time interval as specified by the controller.

3. The method of claim 1, wherein the first frequency and the second frequency are randomly selected by the controller.

4. The method of claim 1, wherein the first frequency and the second frequency are set according to a frequency table.

5. The method of claim 1, further comprising allocating the first time interval and the second time interval by the controller, wherein the first time interval and the second time interval are not adjacent.

6. The method of claim 2, further comprising receiving one of the first sounding transmission, the second sounding transmission, the third sounding transmission, and the fourth sounding transmission at a mobile radio station in the HF cellular system.

7. A method for mitigating sounding interference in a high frequency (HF) cellular system, the method comprising:
transmitting a first sounding transmission on a channel from a first base station at a first frequency during a first time interval as instructed by a controller coupled to the first base station, wherein the controller includes a base station table for a plurality of base stations including the first base station and a second base station and a frequency table for a plurality of frequencies including the first frequency and a second frequency;
transmitting a second sounding transmission on the channel from the second base station at the second frequency during a second time interval as instructed by the controller coupled to the second base station;
transmitting a third sounding transmission on the channel from the first base station at the second frequency during a third time interval as instructed by the controller; and
transmitting a fourth sounding transmission on the channel from the second base station at the first frequency during a fourth time interval as instructed by the controller.

8. The method of claim 7, further comprising randomly selecting the first frequency and the second frequency from entries for the plurality of frequencies in the frequency table.

9. The method of claim 7, further comprising selecting the first frequency and the second frequency in a specified order from the frequency table having entries for the plurality of frequencies.

10. The method of claim 7, wherein the first time interval, the second time interval, the third time interval, and the fourth time interval are predefined and contiguous.

11. The method of claim 7, wherein the first time interval, the second time interval, the third time interval, and the fourth time interval are predefined and noncontiguous.

12. The method of claim 7, further comprising receiving at least one of the first sounding transmission, the second sounding transmission, the third sounding transmission, and the fourth sounding transmission at a high frequency (HF) terminal.

13. The method of claim 7, wherein the at least one of the first frequency and the second frequency correspond to a calling frequency within the HF cellular system.

14. The method of claim 7, wherein the at least one of the first frequency and the second frequency differ from a calling frequency within the HF cellular system based on an adjacency requirement.

15. The method of claim 14, further comprising receiving a call at the calling frequency from a high frequency (HF) terminal within the HF cellular system at a receiving channel while transmitting one of the first sounding transmission and third sounding transmission from a transmission channel at the first base station.

16. The method of claim 7, wherein the base station table includes a field to indicate whether at least one of the plurality of base stations in the base station table may not transmit a sounding transmission.

17. A method for mitigating sounding interference in a high frequency (HF) cellular system, the method comprising:
transmitting a first sounding transmission on a channel from a first base station at a first frequency during a first time interval as instructed by a controller coupled to the first base station, wherein the controller includes a base station table for a plurality of base stations including the first base station and a second base station and a frequency table for a plurality of frequencies including the first frequency and a second frequency;
transmitting a second sounding transmission on the channel from the second base station at the second frequency during the first time interval as instructed by the controller coupled to the second base station;
transmitting a third sounding transmission on the channel from the first base station at the second frequency during a second time interval as instructed by the controller; and
transmitting a fourth sounding transmission on the channel from the second base station at the first frequency during the second time interval as instructed by the controller.

18. The method of claim 17, wherein the at least one of the first frequency and the second frequency correspond to a calling frequency within the HF cellular system.

19. The method of claim 17, wherein the at least one of the first frequency and the second frequency differ from a calling frequency within the HF cellular system based on an adjacency requirement.

20. The method of claim 19, further comprising receiving a call at the calling frequency from a high frequency (HF) terminal within the HF cellular system at a receiving channel while transmitting one of the first sounding transmission and third sounding transmission from a transmission channel at the first base station.
